(19) United States
(12) Patent Application Publication
(10) Pub. No.: US 2011/0174195 A1
(43) Pub. Date: Jul. 21, 2011

(54) USE OF AN EXOTHERMIC MIXTURE FOR MANUFACTURING ASPHALT CONCRETE

(76) Inventors: Didier Lesueur, Rhode Saint Genese (BE); Frédéric Delfosse, Pessac (FR); Jean-Valery Martin, Hopewell, NJ (US)

(21) Appl. No.: 12/865,610

(22) PCT Filed: Jan. 30, 2009
(86) PCT No.: PCT/EP2009/051076

§ 371 Date: Mar. 4, 2011

(30) Foreign Application Priority Data
Feb. 1, 2008 (FR) 0850644

(51) Int. Cl. C04B 24/36; C09K 5/00

(52) U.S. Cl. 106/668; 252/71

(57) ABSTRACT

The present invention relates to the use of an exothermic mixture of at least i) an acidic anhydride or an acid salt and of at least ii) a basic anhydride or a basic salt, in a cold, warm or semi-warm bituminous mix based on a bituminous binder containing water in order to increase the temperature of the bituminous mix. It also relates to a process for manufacturing a bituminous mix using the exothermic mixture, to the bituminous mix capable of being obtained by this process and to the use thereof for the manufacture of a road surface. It additionally relates to the use of the exothermic mixture in order to dry the aggregates and to the aggregates containing this mixture. Finally, it relates to the use of the exothermic mixture in a bitumen emulsion.

The present invention concerns the use of a mixture of additives used in the composition of road materials, in particular asphalt concretes, as well as a process for using this mixture. The use of this mixture in such formulations allows increasing the temperature of the asphalt concrete in contact with water. This temperature increase considerably improves the conditions for implementing and applying road materials and also improves their mechanical properties.

Asphalt concrete is a mix of at least aggregates and a bituminous binder. Typically and nonrestrictively, a sufficient quantity of binder to obtain 1 to 15 parts by mass of residual asphalt is mixed with 85 to 99 parts by mass of aggregate (by dry weight). Depending on the composition and especially the aggregate skeleton, there are continuous or discontinuous, thick, thin, very, even ultra-thin, open (porous or providing drainage), grained, semi-grained, dense or semi-dense, possibly storable, etc., asphalt concretes well known to the person skilled in the art, generally standardized and described, for example, in the two-volume work “Asphalt Concretes” published conjointly by the union des syndicate des industries routières de France (French Road Industry Union, USIRF) and the Revue Générale des Routes et Aérodromes (General Review of Roads and Airfields) (Paris, 2001). Additives may be added, either to the binder, the aggregate or the asphalt concrete. The manufacture of the asphalt concrete, i.e., how the constituents are mixed, may be achieved in various ways. There are generally two families of processes: “hot” processes and “cold” processes. More recently, processes called “warm” or “half-warm” have been introduced, in between the two. The distinction between the processes essentially depends on the aggregate temperature.

In the hot process, the aggregates are heated in devices called dryers to dry them, thus allowing the asphalt to adhere well to the aggregate. The asphalt is also heated to temperatures around 160° C. in order to lower the viscosity and permit good coating of the aggregates. The asphalt concrete thus formed is then applied hot (typically at higher than 150° C.) onto the roadway and then compacted while still hot; the initial high temperature guarantees its workability. The material then becomes rigid as it cools.

In cold processes, the aggregates are not dried and are mixed as is, i.e., with their natural humidity and at ambient temperature. The asphalt can then have various forms, the most common being an emulsion of asphalt that provides a product that is not very viscous, so it can be worked at ambient temperature. The emulsion is sometimes lightly heated to temperatures around 50° C. Another means, still uncommon but increasingly used, consists of foaming the hot asphalt (typically 160° C.) in contact with a little water injected directly into the asphalt according to suitable processes, then to mix this foam with the aggregate with its natural humidity. Additives may be added to the asphalt and/or the water injected to modify the properties of the foam, especially its stability and its volume.

Processes called warm or half-warm are still not commonly used, and are sometimes called something different (half-hot, etc.), but the person skilled in the art will clearly recognize that they consist of either slightly reheating the aggregate, but not enough to completely dry it, or drying it at temperatures just above 100° C. Several processes exist; for example, the binder can be introduced in the same forms as for cold asphalt concretes (asphalt emulsion or foam). Also, and in particular when the aim is to decrease the manufacturing and application temperature of hot asphalt concretes, in order to limit the emission of fumes, this may require the use of additives or original processes in order for the asphalt concrete to maintain a degree of workability compatible with its use at temperatures lower than those usually used.

Hot coating is clearly predominant because it has the advantage of assuring a strong and nearly instant cohesion of the final asphalt concrete due to uniform coating of the aggregates and rapid cooling, but nevertheless has a certain number of problems. In fact, the temperatures necessary for its use consume a great deal of energy, which has a significant economic impact on the final cost of asphalt concrete. In addition, these high temperatures increase emissions of volatile organic compounds (VOCs), dust and fumes that are harmful to the environment and to the workers around these materials. Another limitation arises from the need to store and transport the hot asphalt before its final use. Finally, the high temperature during mixing causes accelerated aging of the asphalt, which limits durability, rendering the roadway more sensitive to cracking phenomena.

The other processes, warm and half-warm, help reduce these disadvantages, and the most effective in this sense are, logically, cold processes. They sometimes have limitations, however, in particular mechanical properties that change over time, generally called curing.

Thus, in the case of cold asphalt concretes with asphalt emulsion, these changes cause the emulsion to break, that is to say, to go from an initial state where the asphalt is dispersed in the form of fine droplets in an aqueous phase (emulsion) to a final state where the asphalt constitutes a film coating the aggregates. This arises not only from the presence of water to be evacuated, which also prevents compacting as effectively as with hot asphalt concretes, but also from complex interactions between the emulsion and the aggregate.

In the case of cold asphalt concretes with asphalt foam, these changes are not well understood, and most likely arise in part from the presence of water to be evacuated, which also prevents compacting as effectively as with hot asphalt concretes. These problems give cold asphalt concretes mechanical properties that change over time (called curing) and consequently, they can sometimes require a very long time before being reopened to traffic to allow the material to set, causing increased inconveniences for users. These effects become more marked the lower the ambient temperature and the higher the humidity, rendering the application of such materials in cold temperatures, typically below 10° C., difficult or even technologically risky.

Warm and half-warm asphalt concretes are currently being explored to alleviate these problems, but at the expense of an energy consumption that obviously remains greater than for cold asphalt concrete.

The authors of WO 2005/028756 attempt to resolve these problems by mechanically raising the temperature of the cold asphalt concrete to 30 to 65° C. when it is applied (heating by infrared or ultraviolet radiation or high frequency waves or microwaves or contact with hot air). However, this additional step requires the use of a special heating device and thus a modification of the current devices for applying or manufacturing cold asphalt concretes. Furthermore, this step requires energy for heating. Therefore, it would be useful to find a less complicated and more energy-saving solution to the problems of the prior art.

The inventors thus discovered, surprisingly, that a mixture of particular additives, once mixed with cold asphalt concrete, allowed raising the temperature by means of an exothermic reaction with water. The temperature increase can thus be obtained without having to heat either the aggregate or the binder beforehand, and without the use of a special heating device for the asphalt concrete, thus permitting substantial energy savings. The advantages of this temperature increase are:
improving the workability of the asphalt concrete by reducing viscosity of the bituminous binder and therefore increasing compaction in place after applying and compacting;
improving the cohesion and speed of setting of the cohesion of the asphalt concrete to obtain an accelerated hardening of the surface, thus limiting sensitivity problems of the resistance of the usual cold asphalt concrete surfaces;
reducing the residual water content of the asphalt concrete to increase the curing speed and thus reduce the time until the surface can be traveled on;
increasing the final mechanical strength of the asphalt concrete;
improving the aggregate coating quality, which is key for good resistance of the asphalt concrete to the effect of water, as well as to surface damage;

The present invention therefore concerns the use of an exothermic mixture of at least i) one acid anhydride or acid salt and at least ii) one basic anhydride or basic salt, in an asphalt concrete containing water, which can be a cold, warm or half-warm asphalt concrete, and in particular an asphalt concrete with asphalt emulsion or foam, to increase the temperature of the asphalt concrete.

To better understand the invention, it seems useful to give the following definitions:
asphalt means a road asphalt or any composition essentially containing asphalt at typically more than 95% by mass and possibly one or more polymers and/or one or more acids or bases and/or one or more emulsifiers and/or one or more viscosifiers and/or one or more fluxes and/or one or more plasticizers and/or any other additive allowing adjusting the properties of the composition. For example, road asphalts, pure asphalts, fluxed or fluidized asphalts, asphalts modified by polymers, semi-blown asphalts, asphalts partially modified by blown asphalt, and all combinations of these asphalts. Asphalts modified by polymers are defined by standard NF EN 125291 and the document “Technical Guide: use of modified binders, special asphalts and asphalts with additives in roadwork” published by the Laboratoire Central des Ponts et Chaussées (Central Laboratory of Bridges and Roadway, LCPC)” (ISSN 1151-1516 ISBN 2-7208-7140-4). Among the polymers usable to modify asphalt, the following can be named: styrene-butadiene copolymers, styrene-isoprene copolymers, ethylene-vinyl acetate copolymers (EVA), terpolymers, such as, for example, the compound of an ethylene chain with butyl acrylate and methyl glycidyl acrylate functional groups that ensure good stability of the asphalt/polymer mixture, and elastomers and plastomers that greatly improve cracking and rutting. By extension, it can also mean a non-asphalt synthetic binder seeking to reproduce the properties of asphalt without the black color, thus providing non-black asphalt concretes;
bituminous binder means any composition containing asphalt and possibly one or more additives and/or one or more emulsifiers and/or one or more viscosifiers and/or one or more fluxes and or one or more plasticizers and/or any other additive allowing adjusting the properties. For example, asphalts, asphalts modified by polymers, asphalt emulsions and asphalt foam can be named.
asphalt concrete means a calibrated mixture of aggregates and a bituminous binder, possibly containing one or more additive(s), for example organic or mineral fibers, rubber crumbs, possibly from recycled tires, various waste (cables, polyolefins, etc.) as well as their mixtures in all proportions. Its preferred field of application is road construction, but it can also be used to seal a structure or a dam;
aggregates are road aggregates of various origins, including aggregates coming from quarries or gravel pits, recycled products such as aggregates coming from milling of old asphalt concretes, factory rejects, recycled building materials (demolished concrete, etc.), slag, shale, artificial aggregates from all sources, especially from municipal solid waste incinerator (MSWI) bottom ash, as well as their mixtures in all proportions. The aggregates generally have a particle size chosen within the range of 0/Dₘₐₓ, Dₘₐₓ being the maximum diameter of the aggregate such as defined according to the standard XP P 18-540 and generally ranging from 4 to 31.5 mm. The aggregates generally contain fine mineral particles, defined as aggregates that can pass through a screen of 0.063 mm, natural or introduced, such as fine limestone (calcium carbonate), cement or hydrated lime.

The exothermic mixture of compounds i) and ii), which serves as the additive according to the present invention, is particularly described in U.S. Pat. No. 6,248,257.

Examples of acid anhydride (compound i)) usable in the exothermic mixture according to the present invention include phosphorus pentoxide (P₂O₅); sodium monophosphate; partially hydrated acid anhydrides such as polyphosphoric acid; other non-metal oxides such as, for example, B₂O₃ and BO; carboxylic acid anhydrides such as acetic anhydride, formic anhydride, propionic anhydride, butyric anhydride, isobutyric anhydride, valeric anhydride, isovaleric anhydride, pivalic anhydride, caproic anhydride, caprylic anhydride, capric anhydride, lauric anhydride, malonic anhydride, succinic anhydride, glutaric anhydride, adipic anhydride, pimelic anhydride, phthalic anhydride and maleic anhydride or a mixture of these. Phosphorous pentoxide and sodium monophosphate or their mixtures are especially advantageous in the scope of the present invention. Phosphorus pentoxide is even more particularly advantageous.

Examples of basic anhydrides (compound II)) usable in the exothermic mixture according to the present invention include basic oxides, partially hydrated, for example, calcium oxide or lime (CaO), which is well known in the prior art to contain certain calcium hydroxides. Other examples of basic anhydrides include oxides of metals selected from among lithium, sodium, potassium, rubidium, cesium, magnesium, strontium and barium. Thus, these oxides include Li₂O, Na₂O, K₂O, Rb₂O, Cs₂O, MgO (magnesia), CaO (lime), SrO, and BaO. Lime (CaO) and magnesia (MgO) or their mixtures are especially advantageous in the scope of the present invention. Lime (CaO) is even more especially advantageous.

In the scope of the present invention, the term “acid salt” refers to a salt that, after being diluted in water, decreases the pH of the aqueous solution below 7, and the term “basic salt” refers to a salt that, after dissolution in water, increases the pH of the aqueous solution above 7.

Thus, examples of acid salts (compounds i)) usable in the exothermic mixture according to the present invention include aluminum chloride (AlCl₃), Zinc chloride (ZnCl₂), titanium tetrachloride (TiCl₄), ferrous chloride (FeCl₂), ferric chloride (FeCl₃) and ferric nitrate (Fe(NO₃)₃). Aluminum chloride is the preferred acid salt due to the high increase in heat that it generates.

The basic salts (compound II)) that can be used in the exothermic mixture according to the present invention are sodium acetate, sodium benzoate and potassium ascorbate. Sodium acetate is the preferred basic salt.

The advantageous exothermic mixtures in the scope of the present invention are those that have one or more of the following properties: 1) the relatively large production of heat by weight during reaction with water; 2) the formation of reaction products that are not classified as dangerous under the legislation in effect, especially in Europe (directives 1967/548/EC and 1988/379/EC and their subsequent updates) and in North America, on the classification of substances and preparations. Advantageously, compound i) is an acid anhydride and compound II) is a basic anhydride. In particular, the reaction product or products should not cause the deterioration of one or more of the physicochemical properties of one or more of the constituents of the asphalt concrete, or have a toxic or ecotoxic classification according to the standards in effect.

The exothermic mixture of phosphorous pentoxide and lime or the exothermic mixture of sodium monophosphate and magnesia or the exothermic mixture of phosphorus pentoxide and magnesia are particularly advantageous in the scope of the present invention.

The exothermic mixture of phosphorus pentoxide and lime is even more particularly advantageous in the scope of the present invention due to the substantial production of heat from hydration and neutralization reactions.

In fact, in the scope of the present invention, heat is produced by hydration of at least one acid anhydride, acid salt, basic anhydride or basic salt. Additional heat is also produced by neutralizing the acidic or basic hydration products obtained. Advantageously, successive or subsequent reactions producing heat give a final product with a pH comprised between 4 and 10 and advantageously between 6 and 8.

Examples of the composition of the exothermic mixture according to the present invention are given in Table 1 below (the quantity of water by weight is not included in the table):

TABLE 1

| | | | Heat |
|---|---|---|---|
| Compound i) | Compound ii) | Product obtained | production |
| (acid) | (base) | after reaction | in kJ/kg |
| AlCl₃ | MgO | Al(OH)₃ + MgCl₂ (aq) | 2349 |
| FeCl₃ | MgO | Fe(OH)₃ + MgCl₂ (aq) | 1465 |
| P₂O₅ | MgO | Mg₃(PO₄)₂ (s) | 1968 |
| AlCl₃ | Na₂O | Al(OH)₃ + NaCl (aq) | 3903 |
| AlCl₃, 6H₂O | Na₂O | Al(OH)₃ + NaCl (aq) | 1435 |
| NaHCO₃ | Na₂O | Na₂CO₃ (aq) | 1251 |
| FeCO₃ | Na₂O | Na₂CO₃ (aq) + FeO | 1505 |
| FeCl₃, 6H₂O | Na₂O | Fe(OH)₃ + NaCl (aq) + H₂O | 2335 |
| HC₂H₃O₂ | Na₂O | NaC₂H₃O₂ (aq) + H₂O | 2617 |
| B₂O₃ | Na₂O | NaBO₂ (aq) | 2708 |
| B₂O₃ | Na₂O | Na₂B₄O₇ (s) | 2038 |
| P₂O₅ | Na₂O | Na₃PO₄ (aq) | 3915 |
| P₂O₅ | Na₂O | Na₂HPO₄ (aq) | 3615 |
| (CH₃CO)₂O | Na₂O | NaC₂H₃O₂ (aq) | 2512 |
| P₂O₅ | CaO | Ca₃(PO₄)₂ (s) | 2407 |
| FeCl₃ | CaO | Fe(OH)₃ + CaCl₂ (aq) | 1454 |
| AlCl₃ | CaO | Al(OH)₃ + CaCl₂ (aq) | 2363 |
| C₄H₄O₃ | CaO | CaC₄H₂O₃ | 1765 |
| H₂C₂O₄ | CaO | CaC₂H₂O₄ (aq) + H₂O | 1463 |
| (CH₃CO)₂O | CaO | Ca(C₂H₃O₂)₂ (aq) | 1619 |

Advantageously, the exothermic mixture according to the invention, i.e., compounds i) and ii) of the exothermic mixture and therefore the anhydrides and the salts, are in the solid or liquid form at ambient temperature and are advantageously in the solid form. In fact, this feature allows easy handling of the exothermic mixture.

The mass ratio between (acid anhydride or acid salt) and (basic anhydride or basic salt) in the exothermic mixtures according to the present invention can vary greatly. This mass ratio of the compounds is generally selected to increase the production of heat and give a neutral reaction product. Thus, an excess by weight of either of compounds i) or ii) of the exothermic mixture may be necessary to obtain the reaction.

Advantageously, a mass ratio of the acid and basic compounds respectively comprised between 1/99 and 99/1 is used. Advantageously, this ratio is comprised between 70/30 and 30/70 and even more advantageously between 55/45 and 45/55.

The selection of the particular compounds of the exothermic mixture producing heat according to the present invention also depends on the quantity of heat desired for a particular application. Advantageously, in the scope of the present invention, it is useful to obtain a temperature increase of the asphalt concrete from 1 to 100° C., and advantageously, from 5 to 20° C., regardless of the initial asphalt concrete temperature. Generally, the temperature is increased so as to control the temperature when the asphalt concrete is applied.

The asphalt concrete application temperature means the asphalt concrete temperature during spreading or compacting.

Transportation is also considered when choosing the temperature increase, so that the asphalt concrete has the necessary temperature for its application.

The exothermic mixture according to the invention is activated by coming into contact with the water contained in the asphalt concrete, which, for example, can come from the natural humidity of the aggregate, water introduced during manufacture of the asphalt concrete or even the asphalt emulsion and/or in the aggregates. A retarder can be included in the exothermic mixture to adjust, and typically delay, the production of heat by the exothermic mixture. Such a retarder therefore controls the exothermic reaction and, in particular, the heat production kinetics. The retarder limits access to one of the constituents of the formula by the other reactants making up the formula considered (limiting the diffusion of water, reducing the solubility of one or more constituents, etc.). Such a retarder is also advantageously chosen from among the following list:
Borax, boric or orthoboric acid or more generally the majority of borate-based compounds
Sodium chloride
Tartaric acid and its salts
Adipic acid and its salts
Citric acid and its salts
Glutaric acid and its salts
Stearic acid and its salts
Oxalic acid and its salts
Acetohydroxamic acid
Fluorides and silicofluorides
Alkaline or alkaline earth salts of phosphates and polyphosphates such as pyrophosphate, tripolyphosphate, and hexamethphopshate
Commercial products such as Acumer® 1000 from Rohm and Haas, or Millsperse® 956 or Drewgard® 4006 from Ashland, etc.

The quantity of retarder included in the exothermic mixture according to the present invention will depend on the quantity of heat desired, in particular for the compounds of the exothermic mixture, and the desired delay effect. Advantageously, the retarder represents approximately 1 to 50% by weight of the exothermic mixture according to the present invention, more advantageously between 1 and 20% by weight of the exothermic mixture, and even more advantageously between 5 and 14% by weight of the exothermic mixture. Advantageously, the retarder allows delaying heat generation from several minutes to several hours (2 hours for example).

In one particular embodiment of the invention, the exothermic mixture according to the invention is used in a quantity comprised between 0.1 and 10% by weight with regard to the total weight of the dry aggregates of the asphalt concrete, advantageously between 0.5 and 6% by weight with regard to the total weight of the dry aggregates of the asphalt concrete, and more advantageously between 1 and 2% by weight with regard to the total weight of the dry aggregates of the asphalt concrete.

The present invention also concerns a manufacturing process for a cold, warm or half-warm asphalt concrete for road surfacing, by coating of aggregates with an asphalt binder containing water, advantageously in emulsion or in the form of an asphalt foam, characterized in that an exothermic mixture according to the invention is added to the aggregates and/or the mixture of aggregates/bituminous binder containing water, to obtain a temperature increase of the asphalt concrete, advantageously comprised between 5 and 20° C. Thus, the exothermic mixture according to the invention permits, for example, extending the application period of cold asphalt concretes, in particular for external temperatures below 10° C., and more specifically between −10° C. and 10° C. In a similar manner, it can also be used to adjust the initial mechanical properties, i.e., during application, or the final mechanical properties, i.e., once in place, of warm or half-warm asphalt concretes.

The process according to the invention can therefore be used to manufacture all types of cold, warm or half-warm asphalt concretes, and advantageously for an asphalt concrete containing a bituminous binder in the form of an asphalt emulsion or foam.

The aggregates used in the process according to the invention can be all the types of aggregates defined previously.

In one advantageous embodiment, the exothermic mixture according to the invention is added into the aggregates and/or fines before coating with the bituminous binder containing water.

In another advantageous embodiment, the exothermic mixture according to the invention is added during coating of the aggregates with the bituminous binder containing water, i.e., during mixing of the aggregates and the bituminous binder containing water.

In a third advantageous embodiment, the exothermic mixture according to the invention is added onto the asphalt concrete after its application, advantageously after it is spread and before or after it is compacted.

In each of these three embodiments, if a retarder is necessary, it is added at the same time as the exothermic mixture.

According to another advantageous embodiment, compounds i) and ii) of the exothermic mixture according to the invention are incorporated separately with one of the other compounds of the asphalt concrete (aggregates and bituminous binder containing water) so as to induce an exothermic reaction when they come together. For example, compound i) can be mixed with the aggregate and compound II) can be mixed with the bituminous binder containing water so that the exothermic reaction is produced during mixing of the aggregates with the binder. The retarder, if used, could also be introduced with one and/or the other reactant.

Thus, the exothermic mixture according to the invention can either be added to the aggregate, or even to a given fraction of aggregates (mineral fines, sand, gravel, etc.) or directly into the asphalt concrete when it is manufactured, when it is applied (during spreading, compacting or even just before or just after one of these steps) or even after its application. The asphalt concrete is generally applied by a step of spreading on the roadway and a compacting step. Generally, after coating, the asphalt concrete obtained may be stored and then transported to the worksite to be applied if the coating is not done on the worksite. Thus, the cold asphalt concrete can be heated by addition of the exothermic mixture according to the invention and possibly a retarder, before spreading, i.e., after coating and before or after transportation to the application site, if applicable, whether or not there is a storage phase, and/or during spreading and/or after spreading during compacting.

The temperature increase by means of the exothermic mixture according to the invention notably leads to the increase of temperature of the binder and the water present in the asphalt concrete. The temperature increase of the binder will considerably change its viscosity and therefore improve the quality of coating and workability of the asphalt concrete, for example, its compactabilty.

The present invention also concerns an asphalt concrete that can be obtained by the process according to the present invention. Advantageously, this asphalt concrete comprises the product of the reaction between compounds i) and ii) of the exothermic mixture according to the invention. This reaction product can also provide advantageous properties to the asphalt concrete according to the invention. In fact, it rigidifies the asphalt more than the fines conventionally used and improves the asphalt concrete's resistance to water. This is especially the case when the reaction product is hydroxyapatite (tricalcium phosphate obtained by reaction of the exothermic mixture of lime and phosphoric anhydride with water).

Thus, the exothermic mixture according to the invention permits not only improving the application and curing of asphalt concretes according to the invention while avoiding excess energy costs, but also obtaining an asphalt concrete with improved mechanical properties and a better water resistance, and by means of the reaction product, an asphalt with a better rigidity.

Advantageously, the asphalt concrete according to the invention comprises 5 to 12%, preferably 7 to 10% by weight of binder with regard to the weight of the aggregates.

The asphalt concrete according to the invention can be, for example, an emulsion gravel or a foam gravel, a cold asphalt concrete, a dense or porous cold asphalt concrete, a cold pour asphalt concrete, or an asphalt concrete from on-site or central recycling of an old roadway.

Advantageously, the bituminous binder of the asphalt concrete according to the invention is chosen from among road asphalts, pure asphalts, fluxed or fluidized asphalts, asphalts modified by polymers, semi-blown asphalts, asphalts partially modified by blown asphalt and/or their mixtures, used as such or in emulsion or even in the form of foam.

Asphalt concretes according to the invention (cold or obtained from warm or half-warm processes) have improved mechanical properties, in particular concerning the application and curing period.

The present invention also concerns the use of the asphalt concrete according to the invention for the production of a road surface.

The present invention also concerns the use of an exothermic mixture according to the invention directly in an asphalt emulsion. This emulsion can, for example, be used alone in all applications for the emulsion, for example, bonding layers, surface coatings, sealers or cures, or even be used in the presence of aggregates in an asphalt concrete. The exothermic mixture according to the invention is then introduced, for example when the emulsion is applied by means of a spreader, a ramp, a nozzle, etc., or any means used.

The present invention also concerns an aggregate intended for a cold, warm or semi-warm asphalt concrete based on bituminous binder containing water, characterized in that it contains an exothermic mixture according to the invention.

Advantageously, the aggregate also comprises a retarder, advantageously chosen from boric acid or tripolyphosphate.

Finally, the present invention concerns the use of an exothermic mixture according to the invention to dry the aggregates and/or fines intended for a road surface.

Advantageously, these aggregates and/or fines are intended to be used in a cold, warm, or half-warm asphalt concrete based on bituminous binder in emulsion.

In fact, the exothermic mixture according to the invention can be used with an aggregate mixture alone, natural (soil, gravel, etc.) or recomposed, i.e., in the absence of bituminous binder, in order to change the water content.

The invention will be better understood in reference to the figures and examples that follow.

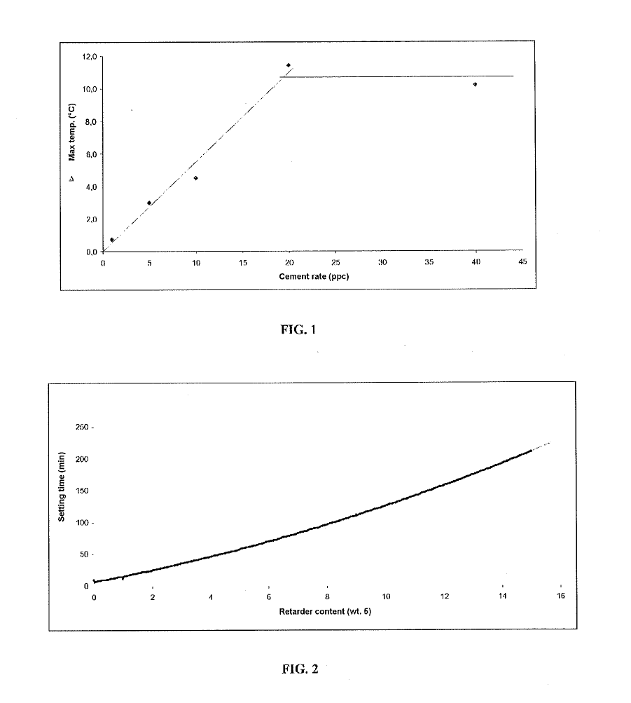

FIG. 1 shows the maximum temperature increase (in ° C.) obtained as a function of the quantity (in % by weight with regard to the total weight of the dry aggregates) of the exothermic mixture according to the invention (sodium monophosphate/magnesia: 60/40) present in a composition of aggregates (200 g) and water (20 g).

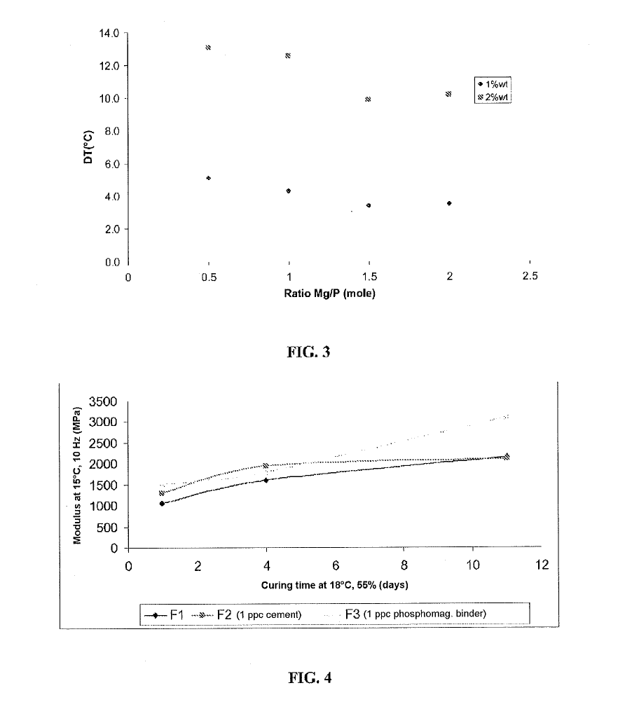

FIG. 2 shows the cement setting time (in minutes), i.e., the time necessary for 100 g of exothermic mixture according to the invention (sodium monophosphate/magnesia: 60/40) to react with 80 g of water, as a function of the quantity of retarder (boric acid) present in the composition in percentage by weight with regard to the total weight of the magnesia present in the composition.

FIG. 3 shows the maximum temperature increase (DT) in ° C. as a function of the molar ratio of magnesia/phosphorus pentoxide (Mg/P) for a composition containing 200 g of road aggregates, 20 g of water and 1 or 2% by weight with regard to the total weight of dry aggregates of the exothermic mixture according to the invention (MgO/P₂O₅).

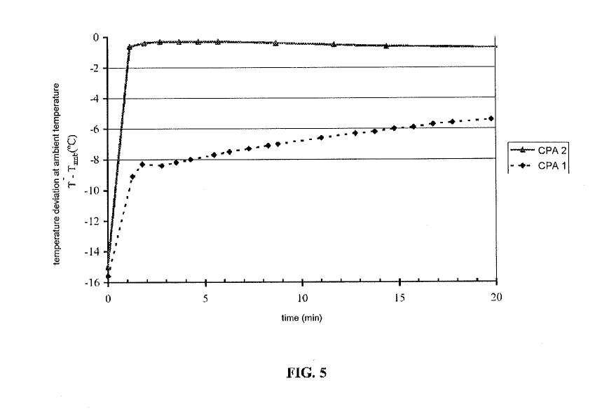

FIG. 4 represents the complex modulus standard (in MPa at 15° C. and 10 Hz) of 3 formulas of cold concrete asphalt tested as a function of curing time (in days) at 18° C. and 55% relative humidity, Formula 1 (F1) not containing the exothermic mixture according to the invention, Formula 2 (F2) containing 1% by weight with regard to the total weight of Portland cement dry aggregates and Formula 3 (F3) containing 1% by weight with regard to the total weight of dry aggregates of an exothermic composition according to the invention (or phospho-magnesia cement=mixture of magnesia and sodium monophosphate).

FIG. 5 represents the temperature deviation between the sample of a cold pour asphalt concrete (CPA) and ambient temperature (T−Tamb) in ° C. for a CPA reference formula 1 not containing the exothermic mixture according to the invention and a CPA formula 2 containing 2% by weight with regard to the total weight of dry aggregates of an exothermic mixture according to the invention (quicklime/phosphorus pentoxide: 77/23).

The invention is illustrated by the following examples

### EXAMPLE 1

### Demonstration of the Exothermic Reaction

Various amounts of an exothermic mixture according to the invention are added to a composition containing road aggregates from the Pt. Pierre quarry and water, so as to demonstrate the potential of the exothermic mixture according to the invention in proportions close to those considered for roadwork. The exothermic mixture according to the invention used in this example is a mixture of sodium monophosphate and magnesia in mass proportions of 60 and 40%, respectively. The constituents are initially left for at least one night at 20° C.

The exothermic reaction is quantified by the temperature increase measured between the reference, without exothermic mixture, and the composition containing aggregates, water, and an increasing quantity of the exothermic mixture according to the invention. The measurement is done in a Dewar flask using a thermocouple immersed in the core of the composition. The temperature deviation thus observed is illustrated in FIG. 1.

Composition by Mass of the Compositions:

Aggregates: 200 g
40% 0/4,
18% 4/6,
42% 6/10.

Water: 20 g

Exothermic mixture according to the invention (sodium monophosphate/magnesia (60/40)): from 0 to 90 g

It seems that an exothermic mixture according to the invention, when it is introduced in sufficient quantity, generates a heat release that increases the aggregate/water composition temperature by more than 10° C. in proportions close to those considered for bituminous compositions.

### EXAMPLE 2

### The Influence of the Addition of a Retarder on the Reaction Between the Exothermic Mixture According to the Invention and Water (Called Cement Setting)

In this example, the exothermic mixture according to the invention is a mixture of sodium monophosphate and magnesia. The retarder used is boric acid. The setting of the phospho-magnesia cement formed by the reaction of the exothermic mixture with water depends on the intensity of the exothermic reaction. Setting measurements by means of the Vicat penetrometer test according to standard NF P15-413 in use in cement manufacturing allows quantifying it. The setting time thus observed is shown in FIG. 2.

Composition by Mass of the Compositions:

Water: 80 g

Exothermic mixture (sodium monophosphate/magnesia (60/40): 100 g

H₃BO₃ retarder: 0 to 16 g

It appears that a suitable retarder delays the reaction time of the exothermic mixture according to the invention with water, which is reflected, for example, by setting times ranging from several minutes to 2 hours.

### EXAMPLE 3

### Another Example of the Exothermic Mixture According to the Invention

Road aggregates from the Pt. Pierre quarry of Example 1 are used to make other compositions containing water and various amounts of another exothermic mixture according to the invention, so as to demonstrate the potential of the exothermic mixture according to the invention in proportions close to those considered for roadwork.

In this example, the exothermic mixture according to the invention is a mixture of magnesia (MgO) and phosphorous pentoxide (P₂O₅) in various molar proportions (between 0.5 and 2). The constituents are initially left for at least one night at 20° C.

The exothermic reaction is quantified by the maximum temperature increase measured between the reference temperature, without exothermic mixture, and the composition containing proportions by mass of 1 to 2% of the mixture according to the invention with regard to the total weight of dry aggregates. The measurement is done in a Dewar flask using a thermocouple immersed in the core of the composition. The temperature deviation thus observed is illustrated in FIG. 3.

Composition by Mass of the Compositions:

Aggregates: 200 g
40% 0/4,
18% 4/6,
42% 6/10.

Water: 10 g

Exothermic mixture of MgO/P₂O₅ with different molar ratios: 1 or 2% by mass with regard to the total weight of dry aggregates

Like the exothermic mixtures based on MgO and sodium monophosphate, the mixtures containing magnesia and phosphoric anhydride generate a significant exothermic reaction for small quantities.

### EXAMPLE 4

### Use of an Exothermic Mixture According to the Invention in a Formula of Cold Asphalt Concrete

The constituents of several cold asphalt concrete formulas (CAC) described below are mixed in a SRC 50/1 mixer from SR Consulting and the asphalt concrete thus obtained is compacted to obtain cylindrical test pieces of 160 mm diameter and approximately 150 mm height with a void content of 17%. The test pieces are then stored at 18° C. and 55% relative humidity for several weeks and the standard of their complex modulus is measured at 15° C. and 10 Hz on an MTS hydraulic press as a function of storage time (FIG. 4).

The exothermic mixture according to the invention used in this example is a phospho-magnesia cement obtained by mixing 60% by mass of magnesia and 40% by mass of sodium monophosphate.

The bituminous emulsion used is a slow-breaking cationic emulsion containing 60% ECL-60 asphalt (according to the standard NF T65 011), manufactured by Eurovia.

Compositions

Reference Formula F1 (in Parts by Mass):

| | |
|---|---|
| ECL-60 bituminous | 9 |
| emulsion: | |
| Total water: | 7 |
| 0/10 Pt. de Pierre | 100 |
| aggregate: | |

Reference Formula F2 (in Parts by Mass):

| | |
|---|---|
| ECL-60 bituminous | 9 |
| emulsion: | |
| Total water: | 7 |
| Portland Cement: | 1 |
| 0/10 Pt. de Pierre | 100 |
| aggregate: | |

Formula According to the Invention F3 (in Parts by Mass):

| | |
|---|---|
| ECL-60 bituminous | 9 |
| emulsion: | |
| Total water: | 7 |
| Phospho-magnesia | 1 |
| cement: | |
| 0/10 Aggregate Pt. de | 100 |
| Pierre: | |

It seems that an exothermic mixture according to the invention added to a cold asphalt concrete like a CAC, improves the mechanical properties, in particular in the curing period, obtaining a higher modulus after at least 6 days of curing.

### EXAMPLE 5

### Use of an Exothermic Mixture According to the Invention in a Formula of Cold Pour Asphalt Concrete

The constituents of several cold pour asphalt concretes (CPA), described below and previously stored for one night in a climate chamber at 5° C., are mixed by hand in an enameled bowl and the CPA thus obtained is spread into an approximately 1 cm thick wafer. A thermocouple is slid into the wafer, which weighs approximately 1 kg, and the temperature is measured as a function of time (FIG. 5). The temperature of the reference CPA (CPA 1), i.e., not containing the exothermic mixture according to the invention, increases as a function of time due to heat exchanges with the outside, since the wafers are placed on a bench in the laboratory where the ambient temperature is approximately 20° C. The difference between the reference CPA curve and that of the CPA containing the exothermic mixture according to the invention thus allows quantifying the exothermic reaction provided by the mixture according to the invention with the CPA.

The exothermic mixture according to the invention used in this example is a mixture of quicklime and phosphorous pentoxide (mass ratio 77/23), prepared in pellets and crushed beforehand. It is the last constituent introduced during mixing of the various components of the formula of the CPA, i.e., just before preparation of the wafer.

It should be specified that CPA formulas generally contain an aqueous solution of cationic surfactant at 10-15 mass %, hereinafter called “CPA setting retarder”. This solution should not be confused with a possible retarder according to the invention, such as described in Example 2. In this example, it is an ADP 5 mixture provided by Probisa.

The asphalt emulsion used is a slow-breaking cationic emulsion containing 60% ECL-2d asphalt according to the Spanish specification described in the “Pliego de Prescripciones Técnicas Generales para Obras de Carreteras y Puentes” (PG 3) (Specifications of the General Techniques for Bridge and Roadway Construction) (2^{nd} Ed., Madrid: Liteam, 2001), manufactured by Probisa.

Compositions

CPA Reference Formula F1 (in Parts by Mass):

| | |
|---|---|
| Montorio aggregate 0/6: | 100 |
| ECL-2d emulsion: | 11.7 |
| Total water: | 10.8 |
| Portland cement: | 0.5 |
| CPA setting retarder: | 0.45 |

CPA Formula F2 According to the Invention (in Parts by Mass):

| | |
|---|---|
| Montorio aggregate 0/6: | 100 |
| ECL-2d emulsion | 11.7 |
| Total water: | 10.8 |
| Exothermic mixture: | 2 |
| CPA setting retarder: | 0.45 |

It seems that an exothermic mixture according to the invention, when it is added into a cold asphalt concrete formula such as CPAs, generates an exothermic reaction that increases the temperature of the CPA initially at 5° C. by more than 8° C. with regard to a CPA that does not contain it.

### EXAMPLE 6

### Rigidifying Effect of the Product of the Reaction of the Exothermic Mixture According to the Invention with Water

In order to simulate the product of the reaction of one of the exothermic mixtures according to the invention with water, 33% by mass hydroxyapatite Ca₁₀(PO₄)₆(OH)₂ (tricalcium phosphate provided by Innophos) were added to a 70/100 Repsol road asphalt, which will be obtained by reacting lime and phosphoric anhydride with water according to Example 5.

For comparison, the same quantities of the various mineral fines commonly used in roadwork have been added: natural fines obtained from a limestone aggregate, a common Portland cement and a calcium carbonate.

The mechanical properties of the asphalt thus modified were assessed by the increase of its softening temperature according to the standard NF EN 1427. The results obtained are gathered in Table 2 below:

TABLE 2

| | | Portland | Calcium | Limestone |
|---|---|---|---|---|
| | Hydroxyapatite | Cement | carbonate | fines |
| Change in | 12.4 | 2.9 | 2.6 | 4.2 |
| softening | | | | |
| temperature | | | | |
| (in ° C.) | | | | |

It appears that the product of the reaction with water of an exothermic mixture according to the invention has the capacity to rigidify the asphalt much more effectively than the fines typically used in the profession.

### EXAMPLE 7

### Increase in Water Resistance of an Asphalt Concrete by Means of the Presence of the Product of the Reaction of an Exothermic Mixture According to the Invention with Water

In the same way as in the preceding example, the product of the reaction with water of one of the exothermic mixtures according to the invention has been incorporated in an asphalt concrete.

The formula of this asphalt concrete corresponds to a semi-dense asphalt concrete S20 according to the Spanish specifications described in the “Pliego de Prescripciones Técnicas Generales para Obras de Carreteras y Puentes” (PG 3) (Specifications of the General Techniques for Bridge and Roadway Construction) (2^{nd} Ed., Madrid: Liteam, 2001). It contains the following ingredients:

Asphalt 40/50 Cepsa-Proas: 4.5 parts per 100 parts dry aggregate (4.5%)

0/6 sand: 35%

6/12 fine gravel: 32%

12/20 gravel: 33%

To this asphalt concrete, 3.5% fines are added, which can be calcium carbonate or a mixture of calcium carbonate (1.25%) and hydroxyapatite (2.25%) identical to the material in the preceding Example 6.

The samples were evaluated by means of the immersion compression test according to Spanish standard NLT-162 that measures simple compression strength of a dry test piece (R) and a test piece after immersion in water (r). The r/R ratio indicates the water resistance of the material.

The results obtained are gathered in Table 3 below:

TABLE 3

| | | Asphalt | Asphalt |
|---|---|---|---|
| | Units | concrete 1 | concrete 2 |
| Limestone fines | % | 3.5 | 1.25 |
| Hydroxyapatite | % | | 2.25 |
| Density | g/cm³ | 2.49 | 2.46 |
| R | MPa | 4.07 | 3.85 |
| r | MPa | 3.09 | 3.13 |
| r/R | % | 76.0 | 81.3 |

It seems that the presence of the product of the reaction with water of an exothermic mixture according to the invention has the capacity to improve the water resistance of an asphalt concrete.

1. A process for increasing the temperature of a cold, warm or half-warm asphalt concrete based on a bituminous binder containing water wherein an exothermic mixture of at least i) one acid anhydride or acid salt and at least ii) one basic anhydride or basic salt is added.

2. Process according to claim 1, wherein the bituminous binder containing water is a bituminous binder in emulsion or an asphalt foam.

3. Manufacturing process of a cold, warm, or half-warm asphalt concrete for a road surface by coating aggregates with a bituminous binder containing water, wherein an exothermic mixture of at least i) one acid anhydride or acid salt and at least ii) one basic anhydride or basic salt is added to the aggregates and/or the mixture of aggregate/bituminous binder containing water, to obtain a temperature increase of the asphalt concrete.

4. Process according to claim 3, wherein the bituminous binder containing water is a bituminous binder in emulsion or an asphalt foam.

5. Process according to claim 3, wherein the exothermic mixture is added into the aggregates and/or fines before coating with the bituminous binder containing water.

6. Process according to claim 3, wherein the exothermic mixture is added during the coating of the aggregates with the bituminous binder containing water.

7. Process according to claim 3, wherein the exothermic mixture is added into the asphalt concrete after its application.

8. Process according to claim 3, wherein a retarder is added at the same time as the exothermic mixture.

9. Process according to claim 3, wherein the acid anhydride is chosen from among phosphorous pentoxide, sodium monophosphate and their mixtures.

10. Process according to claim 3, wherein the basic anhydride is chosen from among lime, magnesia and their mixtures.

11. Process according to claim 3, wherein the exothermic mixture is made up of phosphorous pentoxide and lime.

12. Process according to claim 3, wherein the quantity of the exothermic mixture is comprised between 0.1 and 10% by weight with regard to the total weight of the dry aggregates of the asphalt concrete.

13. Process according to claim 3, wherein the mass ratio of acid anhydride or acid salt/basic anhydride or basic salt is comprised between 70/30 and 30/70.

14. Aggregate intended for a cold, warm or half-warm asphalt concrete based on bituminous binder containing water, wherein it contains an exothermic mixture of at least i) one acid anhydride or acid salt and at least ii) one basic anhydride or basic salt.

15. Aggregate according to claim 14, wherein it also comprises a retarder.

16. Process for drying the aggregates and/or fines intended for a road surface wherein an exothermic mixture of at least i) one acid anhydride or acid salt and at least ii) one basic anhydride or basic salt is added.

17. Process according to claim 16, wherein these aggregates and/or fines are used in a cold, warm, or half-warm asphalt concrete based on bituminous binder containing water.

18. Asphalt concrete that can be obtained by the process according to claim 3.

19. Asphalt concrete according to claim 18, wherein it contains the product of the reaction between i) one acid anhydride or acid salt and ii) one basic anhydride or a basic salt.

20. Asphalt concrete according to claim 18, wherein it comprises 5 to 12% by weight of bituminous binder with regard to the weight of the aggregates.

21. Asphalt concrete according to claim 18, wherein the bituminous binder is chosen from among road asphalts, pure asphalts, fluxed or fluidized asphalts, asphalts modified by polymers, semi-blown asphalts, partially modified asphalts by blown asphalt and/or their mixtures.

22. Road surface containing the asphalt concrete according to claim 18.

23. Process for preparing an asphalt emulsion wherein an exothermic mixture of at least i) one acid anhydride or acid salt and at least ii) one basic anhydride or basic salt is added.

24. Bonding layer containing the emulsion according to claim 23.

25. Surface coating containing the emulsion according to claim 23.

26. Sealing or curing coating containing the emulsion according to claim 23.

27. Process according to claim 3 wherein the temperature increase of the asphalt concrete is comprised between 5 and 20° C.

28. Process according to claim 7 wherein the exothermic mixture is added into the asphalt concrete after it is spread and before or after it is compacted.

29. Process according to claim 8 wherein the retarder is chosen from among boric acid or tripolyphosphate.

30. Process according to claim 12 wherein the quantity of the exothermic mixture is comprised between 0.5 and 6% by weight with regard to the total weight of the dry aggregates of the asphalt concrete.
